(19) United States
(12) Patent Application Publication
(10) Pub. No.: US 2022/0121201 A1
(43) Pub. Date: Apr. 21, 2022

(54) SYSTEM FOR ANTICIPATING FUTURE STATE OF AN AUTONOMOUS VEHICLE

(71) Applicant: Argo AI, LLC, Pittsburgh, PA (US)

(72) Inventors: Alek Williams, Ann Arbor, MI (US); Scott Julian Varnhagen, Ann Arbor, MI (US)

(21) Appl. No.: 17/071,140

(22) Filed: Oct. 15, 2020

(51) Int. Cl. G05D 1/00; G05D 1/02

(52) U.S. Cl. CPC G05D 1/0088; G05D 2201/0213; G05D 1/0212

(57) ABSTRACT

At the start of a path planning cycle for an autonomous vehicle, the system identifies a current plan associated with the autonomous vehicle, a speed plan that defines one or more velocities over time for the autonomous vehicle during the path planning cycle, and a current state of the autonomous vehicle. The current plan includes a spatial plan that defines a proposed trajectory for the autonomous vehicle during the path planning cycle. The current state defines one or more dynamic states of the autonomous vehicle. The system generates a sequence of predicted states of the autonomous vehicle over a prediction horizon period, identifies a predicted state from the sequence that corresponds to a publishing time of an updated plan for the autonomous vehicle, generates the updated plan, and causes the autonomous vehicle to execute the updated plan.

### BACKGROUND

Typical autonomous vehicle (AV) hierarchical path planning systems typically have a path-planner system that plans a trajectory starting from an AV's current state for a path-follower system to follow. The path-follower system can be tuned to aggressively follow the planned trajectory as it is often assumed that the initial deviation from the planned trajectory will be small. However, generation of the planned trajectory can be time and resource intensive. In addition, the state of the AV can diverge significantly from the planned trajectory over the planning period. As such, at the time a planned trajectory is published, the AV state may have deviated significantly from that depicted in the planned trajectory which can result in undesirable AV behavior, such as aggressive control response and oscillatory behavior.

Certain AV path planning systems account for the planning period by having its planned trajectory start from the predicted AV state at the publishing time. These systems then must accurately predict the AV state at the publishing time given the information available at the planning time.

These systems may simulate a model of the AV over the planning period that is initialized at the planning time AV state based on actuation commands last sent to the vehicle platform before the planning time. However, these actuation commands may be inaccurate as they may not take into account the last planned trajectory if there is no time between planning cycles (which can occur if the path planner falls behind schedule).

This document describes methods and systems that are directed to addressing the problems described above, and/or other issues.

### SUMMARY

In various embodiments, a system for predicting a state of an autonomous vehicle includes an on-board electronic device of an autonomous vehicle and a computer-readable storage medium having one or more programming instructions that, when executed, cause the on-board electronic device to perform certain actions. At the start of a path planning cycle for an autonomous vehicle, the system identifies a current plan associated with the autonomous vehicle, a speed plan that defines one or more velocities over time for the autonomous vehicle during the path planning cycle, and a current state of the autonomous vehicle. The current plan includes a spatial plan that defines a proposed trajectory for the autonomous vehicle during the path planning cycle. The current state defines one or more dynamic states of the autonomous vehicle. The system generates a sequence of predicted states of the autonomous vehicle over a prediction horizon period, identifies a predicted state from the sequence that corresponds to a publishing time of an updated plan for the autonomous vehicle, generates the updated plan, and causes the autonomous vehicle to execute the updated plan. The updated plan begins with the identified predicted state

The current state may include one or more of: a positional state of the autonomous vehicle, an orientation of the autonomous vehicle, one or more velocity vectors of the autonomous vehicle, or one or more actuator states of the autonomous vehicle. The prediction horizon period may be longer than the path planning cycle.

The system may provide the current plan and the current state to one or more controllers associated with a path follower system of the autonomous vehicle. The controllers may include one or more lateral controllers and one or more longitudinal controllers. The controllers may include one or more model predictive controllers.

The controllers may include one or more lateral controllers that are configured to pass one or more steering input values that comprise one or more steering wheel angles of the autonomous vehicle through an internal model of vehicle dynamics associated with the lateral controller.

The controllers may include one or more longitudinal controllers that are configured to pass one or more torque input values through an internal model of vehicle dynamics associated with the longitudinal controller.

The system may cause the autonomous vehicle to execute the updated plan by causing the on-board electronic device to send one or more instructions to one or more lateral controllers of the autonomous vehicle that cause the lateral controller to steer the autonomous vehicle to achieve an updated trajectory defined by the an updated spatial plan of the updated plan.

The system may cause the on-board electronic device to generate a sequence of predicted states of the autonomous vehicle over a prediction horizon period by determining one or more control input values based on the current plan and the current state of the autonomous vehicle, and providing one or more of the one or more control input values to a vehicle model to generate the sequence of predicted states based on the provided control input values. Each predicted state in the sequence may be a reflection of a state of the autonomous vehicle being driven by one or more of the control input values.

The system may cause the autonomous vehicle to execute the updated plan by sending one or more instructions to one or more longitudinal controllers of the autonomous vehicle that cause the one or more longitudinal controllers to adjust a speed of the autonomous vehicle to achieve a speed plan of the updated plan.

The system may replace the current plan with the updated plan.

### BRIEF DESCRIPTION OF THE DRAWINGS

FIG. 1 is a block diagram illustrating an example autonomous vehicle system.

FIG. 2 illustrates an example vehicle controller system.

FIG. 3 shows an example LiDAR system.

FIGS. 4 and 5 each illustrate an example method of estimating a future state of an autonomous vehicle.

FIG. 6 is a block diagram that illustrates various elements of a possible electronic system, subsystem, controller and/or other component of an AV, and/or external electronic device.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.” Definitions for additional terms that are relevant to this document are included at the end of this Detailed Description.

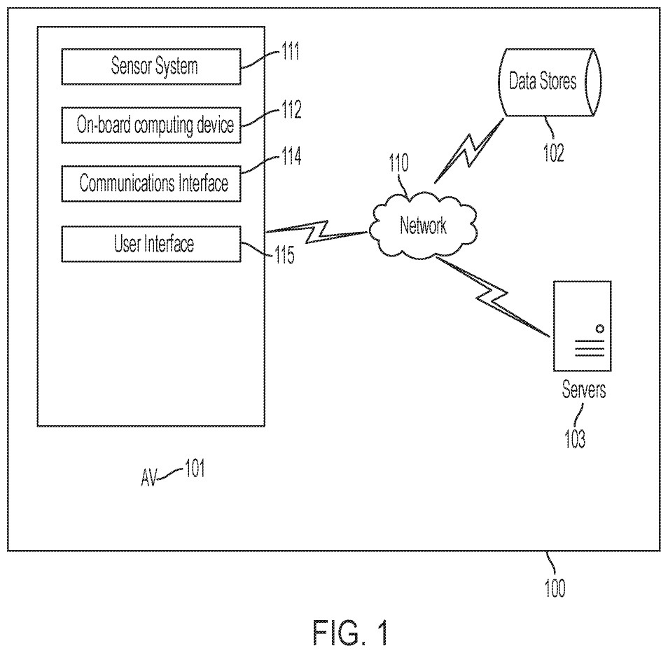

FIG. 1 is a block diagram illustrating an example system 100 that includes an autonomous vehicle 101 in communication with one or more data stores 102 and/or one or more servers 103 via a network 110. Although there is one autonomous vehicle shown, multiple autonomous vehicles may be coupled to each other and/or coupled to data stores 102 and/or servers 103 over network 110. Network 110 may be any type of network such as a local area network (LAN), a wide area network (WAN) such as the Internet, a cellular network, a satellite network, or a combination thereof, and may be wired or wireless. Data store(s) 102 may be any kind of data stores such as, without limitation, map data store(s), traffic information data store(s), user information data store(s), point of interest data store(s), or any other type of content data store(s). Server(s) 103 may be any kind of servers or a cluster of servers, such as, without limitation, Web or cloud servers, application servers, backend servers, or a combination thereof.

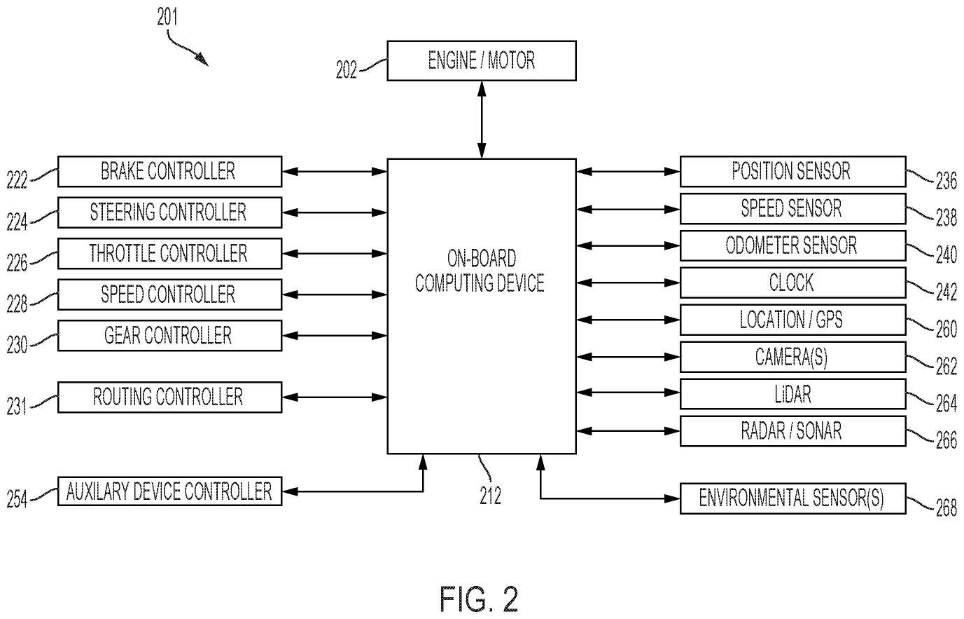

As illustrated in FIG. 1, the autonomous vehicle 101 may include a sensor system 111, an on-board computing device 112, a communications interface 114, and a user interface 115. Autonomous vehicle 101 may further include certain components (as illustrated, for example, in FIG. 2) included in vehicles, such as, an engine, wheels, steering wheel, transmission, etc., which may be controlled by the on-board computing device 112 using a variety of communication signals and/or commands, such as, for example, acceleration signals or commands, deceleration signals or commands, steering signals or commands, braking signals or commands, etc.

The sensor system 111 may include one or more sensors that are coupled to and/or are included within the autonomous vehicle 101. Examples of such sensors include, without limitation, a LiDAR system, a radio detection and ranging (RADAR) system, a laser detection and ranging (LADAR) system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of the autonomous vehicle 101, information about the environment itself, information about the motion of the autonomous vehicle 101, information about a route of the autonomous vehicle, or the like. As autonomous vehicle 101 travels over a surface, at least some of the sensors may collect data pertaining to the surface.

The LiDAR system may include a sensor configured to sense or detect objects in an environment in which the autonomous vehicle 101 is located. Generally, LiDAR system is a device that incorporates optical remote sensing technology that can measure distance to a target and/or other properties of a target (e.g., a ground surface) by illuminating the target with light. As an example, the LiDAR system may include a laser source and/or laser scanner configured to emit laser pulses and a detector configured to receive reflections of the laser pulses. For example, the LiDAR system may include a laser range finder reflected by a rotating mirror, and the laser is scanned around a scene being digitized, in one, two, or more dimensions, gathering distance measurements at specified angle intervals. The LIDAR system, for example, may be configured to emit laser pulses as a beam. Optionally, the beam may be scanned to generate two dimensional or three dimensional range matrices. In an example, the range matrices may be used to determine distance to a given vehicle or surface by measuring time delay between transmission of a pulse and detection of a respective reflected signal. In some examples, more than one LiDAR system may be coupled to the first vehicle to scan a complete 360° horizon of the first vehicle. The LiDAR system may be configured to provide to the computing device a cloud of point data representing the surface(s), which have been hit by the laser. The points may be represented by the LiDAR system in terms of azimuth and elevation angles, in addition to range, which can be converted to (X, Y, Z) point data relative to a local coordinate frame attached to the vehicle. Additionally, the LiDAR may be configured to provide intensity values of the light or laser reflected off the surfaces that may be indicative of a surface type. In examples, the LiDAR system may include components such as light (e.g., laser) source, scanner and optics, photo-detector and receiver electronics, and position and navigation system. In an example, The LiDAR system may be configured to use ultraviolet (UV), visible, or infrared light to image objects and can be used with a wide range of targets, including non-metallic objects. In one example, a narrow laser beam can be used to map physical features of an object with high resolution.

It should be noted that the LiDAR systems for collecting data pertaining to the surface may be included in systems other than the autonomous vehicle 101 such as, without limitation, other vehicles (autonomous or driven), robots, satellites, etc.

FIG. 2 illustrates an example system architecture for a vehicle 201, such as the autonomous vehicle 101 of FIG. 1 autonomous vehicle. The vehicle 201 may include an engine or motor 202 and various sensors for measuring various parameters of the vehicle and/or its environment. Operational parameter sensors that are common to both types of vehicles include, for example: a position sensor 236 such as an accelerometer, gyroscope and/or inertial measurement unit; a speed sensor 238; and an odometer sensor 240. The vehicle 101 also may have a clock 242 that the system architecture uses to determine vehicle time during operation. The clock 242 may be encoded into the vehicle on-board computing device 212, it may be a separate device, or multiple clocks may be available.

The vehicle 201 also may include various sensors that operate to gather information about the environment in which the vehicle is traveling. These sensors may include, for example: a location sensor 260 such as a GPS device; object detection sensors such as one or more cameras 262; a LiDAR sensor system 264; and/or a radar and or and/or a sonar system 266. The sensors also may include environmental sensors 268 such as a precipitation sensor and/or ambient temperature sensor. The object detection sensors may enable the vehicle 201 to detect objects that are within a given distance or range of the vehicle 201 in any direction, while the environmental sensors collect data about environmental conditions within the vehicle's area of travel. The system architecture will also include one or more cameras 262 for capturing images of the environment.

During operations, information is communicated from the sensors to an on-board computing device 212. The on-board computing device 212 analyzes the data captured by the sensors and optionally controls operations of the vehicle based on results of the analysis. For example, the on-board computing device 212 may control braking via a brake controller 222; direction via a steering controller 224; speed and acceleration via a throttle controller 226 (in a gas-powered vehicle) or a motor speed controller 228 (such as a current level controller in an electric vehicle); a differential gear controller 230 (in vehicles with transmissions); and/or other controllers such as an auxiliary device controller 254.

Geographic location information may be communicated from the location sensor 260 to the on-board computing device 212, which may then access a map of the environment that corresponds to the location information to determine known fixed features of the environment such as streets, buildings, stop signs and/or stop/go signals. Captured images from the cameras 262 and/or object detection information captured from sensors such as a LiDAR system 264 is communicated from those sensors to the on-board computing device 212. The object detection information and/or captured images may be processed by the on-board computing device 212 to detect objects in proximity to the vehicle 201. In addition or alternatively, the vehicle 201 may transmit any of the data to a remote server system 103 (FIG. 1) for processing. Any known or to be known technique for making an object detection based on sensor data and/or captured images can be used in the embodiments disclosed in this document.

The on-board computing device 212 may obtain, retrieve, and/or create map data that provides detailed information about the surrounding environment of the autonomous vehicle 201. The on-board computing device 212 may also determine the location, orientation, pose, etc. of the AV in the environment (localization) based on, for example, three dimensional position data (e.g., data from a GPS), three dimensional orientation data, predicted locations, or the like. For example, the on-board computing device 212 may receive GPS data to determine the AV's latitude, longitude and/or altitude position. Other location sensors or systems such as laser-based localization systems, inertial-aided GPS, or camera-based localization may also be used to identify the location of the vehicle. The location of the vehicle may include an absolute geographical location, such as latitude, longitude, and altitude as well as relative location information, such as location relative to other cars immediately around it which can often be determined with less noise than absolute geographical location. The map data can provide information regarding: the identity and location of different roadways, road segments, lane segments, buildings, or other items; the location, boundaries, and directions of traffic lanes (e.g., the location and direction of a parking lane, a turning lane, a bicycle lane, or other lanes within a particular roadway) and metadata associated with traffic lanes; traffic control data (e.g., the location and instructions of signage, traffic lights, or other traffic control devices); and/or any other map data that provides information that assists the on-board computing device 212 in analyzing the surrounding environment of the autonomous vehicle 201.

In certain embodiments, the map data may also include reference path information that correspond to common patterns of vehicle travel along one or more lanes such that the motion of the object is constrained to the reference path (e.g., locations within traffic lanes on which an object commonly travels). Such reference paths may be pre-defined such as the centerline of the traffic lanes. Optionally, the reference path may be generated based on a historical observation of vehicles or other objects over a period of time (e.g., reference paths for straight line travel, lane merge, a turn, or the like).

In certain embodiments, the on-board computing device 212 may also include and/or may receive information relating to the trip or route of a user, real-time traffic information on the route, or the like.

The on-board computing device 212 may include and/or may be in communication with a routing controller 231 that generates a navigation route from a start position to a destination position for an autonomous vehicle. The routing controller 231 may access a map data store to identify possible routes and road segments that a vehicle can travel on to get from the start position to the destination position. The routing controller 231 may score the possible routes and identify a preferred route to reach the destination. For example, the routing controller 231 may generate a navigation route that minimizes Euclidean distance traveled or other cost function during the route, and may further access the traffic information and/or estimates that can affect an amount of time it will take to travel on a particular route. Depending on implementation, the routing controller 231 may generate one or more routes using various routing methods, such as Dijkstra's algorithm, Bellman-Ford algorithm, or other algorithms. The routing controller 231 may also use the traffic information to generate a navigation route that reflects expected conditions of the route (e.g., current day of the week or current time of day, etc.), such that a route generated for travel during rush-hour may differ from a route generated for travel late at night. The routing controller 231 may also generate more than one navigation route to a destination and send more than one of these navigation routes to a user for selection by the user from among various possible routes.

In various embodiments, an on-board computing device 212 may determine perception information of the surrounding environment of the autonomous vehicle 201. Based on the sensor data provided by one or more sensors and location information that is obtained, the on-board computing device 212 may determine perception information of the surrounding environment of the autonomous vehicle 201. The perception information may represent what an ordinary driver would perceive in the surrounding environment of a vehicle. The perception data may include information relating to one or more objects in the environment of the autonomous vehicle 201. For example, the on-board computing device 212 may process sensor data (e.g., LiDAR or RADAR data, camera images, etc.) in order to identify objects and/or features in the environment of autonomous vehicle 201. The objects may include traffic signals, road way boundaries, other vehicles, pedestrians, and/or obstacles, etc. The on-board computing device 212 may use any now or hereafter known object recognition algorithms, video tracking algorithms, and computer vision algorithms (e.g., track objects frame-to-frame iteratively over a number of time periods) to determine the perception.

In some embodiments, the on-board computing device 212 may also determine, for one or more identified objects in the environment, the current state of the object. The state information may include, without limitation, for each object: current location; current speed and/or acceleration, current heading; current pose; current shape, size, or footprint; type (e.g., vehicle vs. pedestrian vs. bicycle vs. static object or obstacle); and/or other state information.

The on-board computing device 212 may perform one or more prediction and/or forecasting operations. For example, the on-board computing device 212 may predict future locations, trajectories, and/or actions of one or more objects. For example, the on-board computing device 212 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, the autonomous vehicle 201, the surrounding environment, and/or their relationship(s). For example, if an object is a vehicle and the current driving environment includes an intersection, the on-board computing device 212 may predict whether the object will likely move straight forward or make a turn. If the perception data indicates that the intersection has no traffic light, the on-board computing device 212 may also predict whether the vehicle may have to fully stop prior to enter the intersection.

In various embodiments, the on-board computing device 212 may determine a motion plan for the autonomous vehicle. For example, the on-board computing device 212 may determine a motion plan for the autonomous vehicle based on the perception data and/or the prediction data. Specifically, given predictions about the future locations of proximate objects and other perception data, the on-board computing device 212 can determine a motion plan for the autonomous vehicle 201 that best navigates the autonomous vehicle relative to the objects at their future locations.

In one or more embodiments, the on-board computing device 212 may receive predictions and make a decision regarding how to handle objects in the environment of the autonomous vehicle 201. For example, for a particular object (e.g., a vehicle with a given speed, direction, turning angle, etc.), the on-board computing device 212 decides whether to overtake, yield, stop, and/or pass based on, for example, traffic conditions, map data, state of the autonomous vehicle, etc. Furthermore, the on-board computing device 212 also plans a path for the autonomous vehicle 201 to travel on a given route, as well as driving parameters (e.g., distance, speed, and/or turning angle). That is, for a given object, the on-board computing device 212 decides what to do with the object and determines how to do it. For example, for a given object, the on-board computing device 212 may decide to pass the object and may determine whether to pass on the left side or right side of the object (including motion parameters such as speed). The on-board computing device 212 may also assess the risk of a collision between a detected object and the autonomous vehicle 201. If the risk exceeds an acceptable threshold, it may determine whether the collision can be avoided if the autonomous vehicle follows a defined vehicle trajectory and/or implements one or more dynamically generated emergency maneuvers is performed in a pre-defined time period (e.g., N milliseconds). If the collision can be avoided, then the on-board computing device 212 may execute one or more control instructions to perform a cautious maneuver (e.g., mildly slow down, accelerate, change lane, or swerve). In contrast, if the collision cannot be avoided, then the on-board computing device 112 may execute one or more control instructions for execution of an emergency maneuver (e.g., brake and/or change direction of travel).

As discussed above, planning and control data regarding the movement of the autonomous vehicle is generated for execution. The on-board computing device 212 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

In the various embodiments discussed in this document, the description may state that the vehicle or a controller included in the vehicle (e.g., in an on-board computing system) may implement programming instructions that cause the vehicle and/or a controller to make decisions and use the decisions to control operations of the vehicle. However, the embodiments are not limited to this arrangement, as in various embodiments the analysis, decision making and or operational control may be handled in full or in part by other computing devices that are in electronic communication with the vehicle's on-board computing device and/or vehicle control system. Examples of such other computing devices include an electronic device (such as a smartphone) associated with a person who is riding in the vehicle, as well as a remote server that is in electronic communication with the vehicle via a wireless communication network. The processor of any such device may perform the operations that will be discussed below.

Referring back to FIG. 1, the communications interface 114 may be configured to allow communication between autonomous vehicle 101 and external systems, such as, for example, external devices, sensors, other vehicles, servers, data stores, databases etc. Communications interface 114 may utilize any now or hereafter known protocols, protection schemes, encodings, formats, packaging, etc. such as, without limitation, Wi-Fi, an infrared link, Bluetooth, etc. User interface system 115 may be part of peripheral devices implemented within vehicle 101 including, for example, a keyword, a touch screen display device, a microphone, and a speaker, etc.

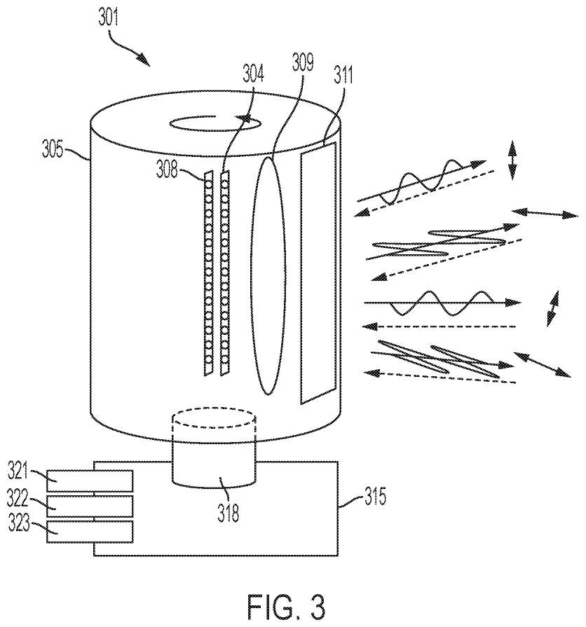

FIG. 3 shows an example LiDAR system 201 as may be used in various embodiments. As shown in FIG. 3, the LiDAR system 201 includes a housing 205 which may be rotatable 360° about a central axis such as hub or axle 218. The housing may include an emitter/receiver aperture 211 made of a material transparent to light. Although the example shown in FIG. 3 has a single aperture, in various embodiments, multiple apertures for emitting and/or receiving light may be provided. Either way, the system can emit light through one or more of the aperture(s) 211 and receive reflected light back toward one or more of the aperture(s) 211 as the housing 205 rotates around the internal components. In an alternative embodiment, the outer shell of housing 205 may be a stationary dome, at least partially made of a material that is transparent to light, with rotatable components inside of the housing 205.

Inside the rotating shell or stationary dome is a light emitter system 204 that is configured and positioned to generate and emit pulses of light through the aperture 211 or through the transparent dome of the housing 205 via one or more laser emitter chips or other light emitting devices. The emitter system 204 may include any number of individual emitters, including for example 8 emitters, 64 emitters or 128 emitters. The emitters may emit light of substantially the same intensity, or of varying intensities. The individual beams emitted by 204 will have a well-defined state of polarization that is not the same across the entire array. As an example, some beams may have vertical polarization and other beams may have horizontal polarization. The LiDAR system will also include a light detector 208 containing a photodetector or array of photodetectors positioned and configured to receive light reflected back into the system. The emitter system 204 and detector 208 would rotate with the rotating shell, or they would rotate inside the stationary dome of the housing 205. One or more optical element structures 209 may be positioned in front of the light emitting unit 204 and/or the detector 208 to serve as one or more lenses or waveplates that focus and direct light that is passed through the optical element structure 209.

One or more optical element structures 309 may be positioned in front of the mirror 302 to focus and direct light that is passed through the optical element structure 309. As shown below, the system includes an optical element structure 309 positioned in front of the mirror 303 and connected to the rotating elements of the system so that the optical element structure 309 rotates with the mirror 302. Alternatively or in addition, the optical element structure 309 may include multiple such structures (for example lenses and/or waveplates). Optionally, multiple optical element structures 309 may be arranged in an array on or integral with the shell portion 311.

Optionally, each optical element structure 309 may include a beam splitter that separates light that the system receives from light that the system generates. The beam splitter may include, for example, a quarter-wave or half-wave waveplate to perform the separation and ensure that received light is directed to the receiver unit rather than to the emitter system (which could occur without such a waveplate as the emitted light and received light should exhibit the same or similar polarizations).

The LiDAR system will include a power unit 321 to power the laser emitter unit 304, a motor 303, and electronic components. The LiDAR system will also include an analyzer 315 with elements such as a processor 322 and non-transitory computer-readable memory 323 containing programming instructions that are configured to enable the system to receive data collected by the light detector unit, analyze it to measure characteristics of the light received, and generate information that a connected system can use to make decisions about operating in an environment from which the data was collected. Optionally, the analyzer 315 may be integral with the LiDAR system 301 as shown, or some or all of it may be external to the LiDAR system and communicatively connected to the LiDAR system via a wired or wireless communication network or link.

The present disclosure generally relates to a system and method for estimating a future state of an AV (e.g., where the AV will be in the future) based on information about how a path-follower system will follow a given path of the AV. As an example, one or more controllers used within a path-follower system may be used to estimate the state of an AV based on the AV's last planned trajectory. These controller(s) may predict the AV state over its prediction horizon, which may be longer than the planning period, using an internal model of the vehicle dynamics. This model may be of higher fidelity or accuracy than a model that is used for path planning purposes.

In various embodiments, one or more systems or subsystems of an AV may be involved in estimating a future state of the AV. For instance, a path planning system, a prediction system, and/or other systems/subsystems or combinations of systems/subsystems of an AV may perform at least a portion of the process(es) described in this disclosure.

A path planning system of an AV may utilize a path planner and a path follower. A path planner may be implemented as hardware, software, and/or a combination of hardware and software. A path planner may create a plan that details a trajectory for an AV to follow. The plan may include a spatial plan that identifies one or more locations that the AV is to pass through. The plan may include a speed plan that identifies the speed (velocity) of the AV over time.

A path follower may be implemented as hardware, software, and/or a combination of hardware and software. A path follower may execute the plan generated by the path planner such that the AV adheres to the spatial plan and the speed plan. A path follower may include one or more controllers such as, for example, one or more lateral controllers and one or more longitudinal controllers. A lateral controller may be responsible for steering the AV's wheels by generating steering wheel angles needed for the AV to execute the plan. The longitudinal controller may regulate an AV's velocity in accordance with the speed plan. A lateral controller and/or a longitudinal controller may be implemented as part of a microcontroller.

It is common for AVs to deviate from a plan. However, these deviations may make it difficult for other AV systems to predict where the AV will be at a future time. When a deviation from a plan is detected, a path planner may be tasked with developing a new path for the AV. However, various AV systems may need to have an estimate of a future state of the AV while the path planner is developing a new plan. The following discussion describes example ways that a system may perform this estimation.

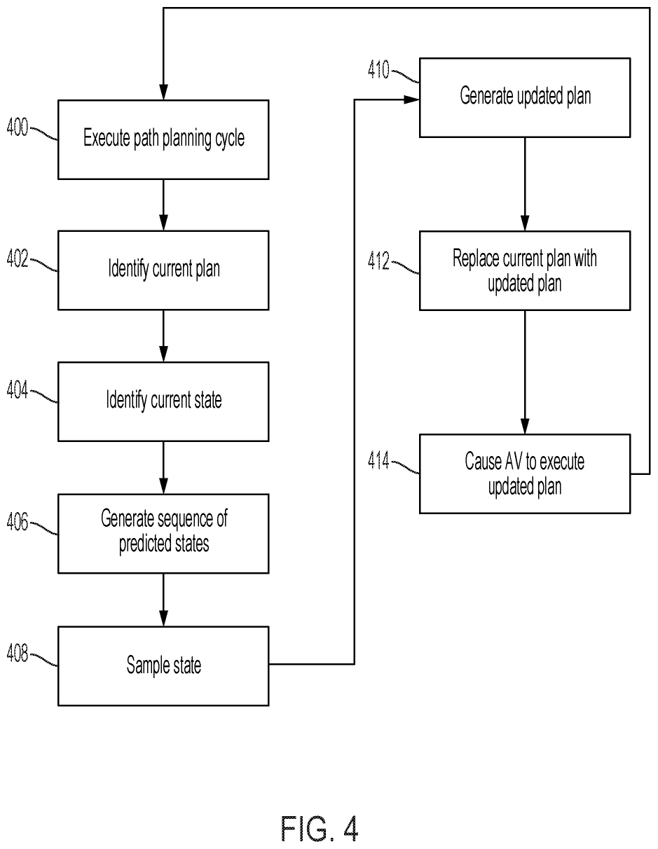

FIG. 4 illustrates an example method of estimating a future state of an autonomous vehicle. As illustrated in FIG. 4, an on-board electronic device of an autonomous vehicle may execute 400 a path planning cycle to generate a new plan for the AV. A path planning cycle refers to a period of time during which an on-board electronic device of an autonomous vehicle analyzes and/or evaluates sensor and other information pertaining to an autonomous vehicle and/or its surroundings and prepares a plan for that autonomous vehicle based at least in part on such information. In various embodiments, an on-board electronic device may execute 400 a path planning cycle at regular or substantially-regular intervals to ensure that the planning process is utilizing fresh information about the environment.

The on-board electronic device may identify 402 the current plan. For example, the on-board electronic device may identify 402 the current plan at the start of the path planning cycle for the AV. The current plan may define a spatial plan and/or a speed plan for the AV during this path planning cycle.

For example, during each planning cycle, a path planning system may determine one or more possible trajectories for an AV from the AV's current location. These trajectories may be determined based on information collected by one or more sensors of the autonomous vehicle such as, for example, speed or other motion information associated with the AV, perception information captured by the AV's sensors, and/or the like. The path planning system may evaluate the determined trajectories to identify an optimized trajectory for the AV.

The on-board electronic device may identify 404 a current state of the AV. A state of an AV refers to one or more dynamic states of an AV. For example, a state may refer to one or more of a positional state of AV, an orientation of an AV, one or more velocity vectors of an AV, an actuator state, lateral offset, heading offset, lateral velocity, yaw rate, steering wheel angle, and/or the like.

In various embodiments, the on-board electronic device may generate 406 a sequence of predicted states for the AV. The on-board electronic device may generate 406 this sequence over a prediction horizon period. A prediction horizon period refers to a number of discrete time steps into the future. In various embodiments, the prediction horizon period may have a longer duration than a path planning cycle for the AV.

The on-board electronic device may generate 406 a sequence of predicted states by providing the current planned trajectory and the current state to one or more controllers. In various embodiments, the one or more controllers may include a lateral controller and/or a longitudinal controller. One or more of the lateral controllers and/or the longitudinal controllers may be the same controllers that are associated with the path follower. Because the most recently available inputs may be used in connection with the same controller(s) that is used in the path follower, the output of the controller(s) may be a reasonable approximation of the process performed by the path follower during the planning period. As such, the predicted AV state at the publishing time will likely be close to the actual AV state at the publishing time.

In various embodiments, one or more controllers may be a model predictive controller, meaning that it implements model predictive control (MPC). MPC uses a model of a system to predict the system's future behavior in response to one or more control actions. MPC may solve a numerical optimization problem to find the optimal control action for the prediction.

MPC may use a vehicle dynamics model to predict a future state of an AV. The numerical optimization problem may be formulated as a quadratic programming problem with linear equality constraints that encode a model of the vehicle dynamics and linear inequality constraints that enforce constraints on the chosen steering wheel angles.

The numerical optimization problem may have an associated cost function. The cost function may be a quadratic function of the vehicle dynamic states (e.g., lateral offset from the desired path) and control inputs to the vehicle dynamics model (e.g., steering wheel angle) over the prediction horizon.

The cost function may be tuned so that one or more of the controllers produces the desired path-following behavior. One or more controllers may use a linearized dynamic bicycle model of vehicle dynamics. For example, the output of a lateral controller may be a sequence of steering input values that start at the present time and extend into the future over its prediction horizon and that minimize the cost function.

One or more controllers may generate a sequence of predicted states over the prediction horizon. For example, a lateral controller may generate one or more predicted states that result from passing steering input values through the lateral controller's internal model of vehicle dynamics. As another example, a longitudinal controller may generate one or more predicted states that result from passing torque input values through the longitudinal controller's internal model of vehicle dynamics. One or more of the predicted states may include information pertaining to one or more dynamic states of the AV at one or more future times over the prediction horizon. As such, the on-board electronic device may generate 406 a sequence of predicted states by providing the current planned trajectory and the current state to one or more controllers, which may apply a vehicle dynamics model to these inputs to generate one or more predicted future states for the AV.

When the path planning system is ready to publish its new plan for the AV, the on-board electronic device may sample 408 the AV state from the one or more predicted states from the generated sequence. The on-board electronic device may sample 408 the AV state that corresponds to the publishing time. The path planning system may use the sampled AV state as the initial AV state for planning.

The on-board electronic device may generate 410 the updated plan. The updated plan may begin with the sampled AV state. In various embodiments, the current plan may be replaced 412 with the updated plan.

In various embodiments, the on-board electronic device may send one or more instructions regarding the updated plan to one or more vehicle controllers, which may cause 414 the autonomous vehicle to execute the updated plan. For example, the on-board electronic device may send one or more instructions regarding the updated plan to one or more lateral controllers, which may cause the AV's wheels to be steered at certain angles to achieve an updated trajectory defined by the spatial plan of the updated plan.

Similarly, the on-board electronic device may send one or more instructions regarding the updated plan to one or more longitudinal controllers, which may cause the AV to accelerate and/or apply brakes to achieve the speed plan of the updated plan.

In various embodiments, the process described above with respect to steps 400-414 may be repeated during the next path planning cycle.

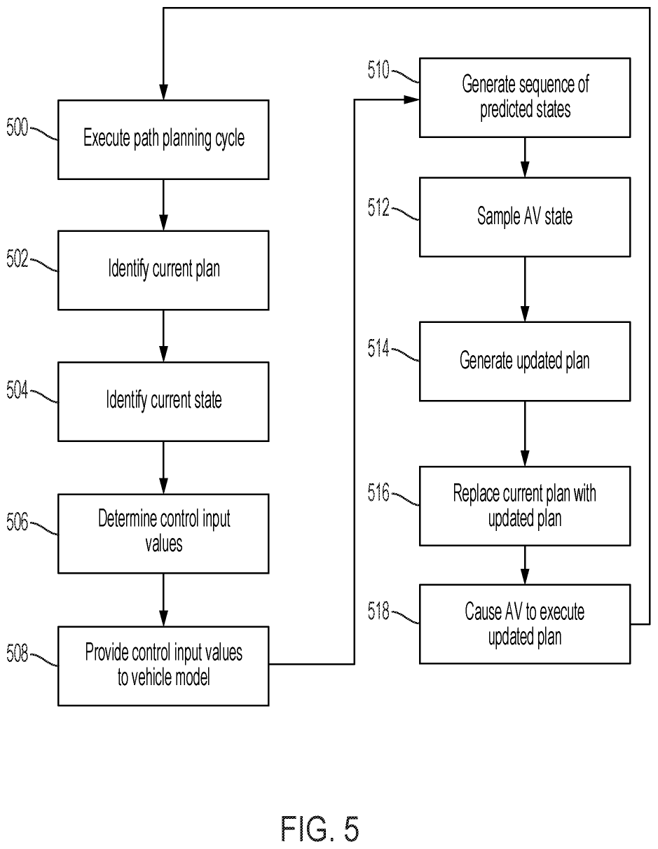

FIG. 5 illustrates another example method of estimating a future state of an autonomous vehicle. As illustrated in FIG. 5, an on-board electronic device of an autonomous vehicle may execute 500 a path planning cycle to generate a new plan for the AV. As discussed above, an on-board electronic device may execute 500 a path planning cycle at regular or substantially-regular intervals to ensure that the planning process is utilizing fresh information about the environment.

The on-board electronic device may identify 502 the current plan. For example, the on-board electronic device may identify 502 the current plan at the start of the path planning cycle for the AV. The current plan may define a spatial plan and/or a speed plan for the AV during this path planning cycle.

The on-board electronic device may identify 504 a current state of the AV. In various embodiments, the on-board electronic device may determine 506 one or more control input values based on the identified current plan and/or the current state of the AV. The control input values may be ones associated with inputs to drive the AV such as, for example, steering wheel angle, longitudinal torque, and/or the like.

The on-board electronic device may provide 508 one or more of the control input values to a vehicle model. The vehicle model may generate 510 a sequence of one or more predicted states for the AV based on the control input values. The predicted states that are generated may be ones that result from the AV being driven by the applicable control values. The sequence may be generated 510 over a prediction horizon period.

In various embodiments, a vehicle model may generate one or more predicted states that result from control input values through the model. One or more of the predicted states may include information pertaining to one or more dynamic states of the AV at one or more future times over the prediction horizon. As such, a sequence of predicted states may be generated by providing one or more control input values to one or more vehicle models.

When the path planning system is ready to publish its new plan for the AV, the on-board electronic device may sample 512 the AV state from the one or more predicted states from the generated sequence. The on-board electronic device may sample 512 the AV state that corresponds to the publishing time. The path planning system may use the sampled AV state as the initial AV state for planning.

The on-board electronic device may generate 514 the updated plan. The updated plan may begin with the sampled AV state. In various embodiments, the current plan may be replaced 516 with the updated plan.

In various embodiments, the on-board electronic device may send one or more instructions regarding the updated plan to one or more vehicle controllers, which may cause 518 the autonomous vehicle to execute the updated plan. For example, the on-board electronic device may send one or more instructions regarding the updated plan to one or more lateral controllers, which may cause the AV's wheels to be steered at certain angles to achieve an updated trajectory defined by the spatial plan of the updated plan.

Similarly, the on-board electronic device may send one or more instructions regarding the updated plan to one or more longitudinal controllers, which may cause the AV to accelerate and/or apply brakes to achieve the speed plan of the updated plan.

In various embodiments, the process described above with respect to steps 500-518 may be repeated during the next path planning cycle.

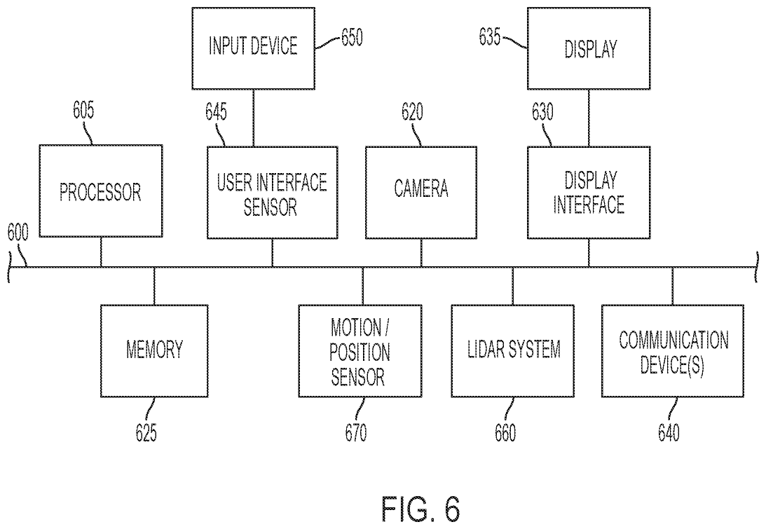

FIG. 6 depicts an example of internal hardware that may be included in any of the electronic components of the system, such as internal processing systems of the AV, external monitoring and reporting systems, or remote servers. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a set of operations, such as a central processing unit (CPU), a graphics processing unit (GPU), a remote server, or a combination of these. Read only memory (ROM), random access memory (RAM), flash memory, hard drives and other devices capable of storing electronic data constitute examples of memory devices 625. A memory device may include a single device or a collection of devices across which data and/or instructions are stored. Various embodiments of the invention may include a computer-readable medium containing programming instructions that are configured to cause one or more processors to perform the functions described in the context of the previous figures.

An optional display interface 630 may permit information from the bus 600 to be displayed on a display device 635 in visual, graphic or alphanumeric format, such as an in-dashboard display system of the vehicle. An audio interface and audio output (such as a speaker) also may be provided. Communication with external devices may occur using various communication devices 640 such as a wireless antenna, a radio frequency identification (RFID) tag and/or short-range or near-field communication transceiver, each of which may optionally communicatively connect with other components of the device via one or more communication system. The communication device(s) 640 may be configured to be communicatively connected to a communications network, such as the Internet, a local area network or a cellular telephone data network.

The hardware may also include a user interface sensor 645 that allows for receipt of data from input devices 650 such as a keyboard or keypad, a joystick, a touchscreen, a touch pad, a remote control, a pointing device and/or microphone. Digital image frames also may be received from a camera 620 that can capture video and/or still images. The system also may receive data from a motion and/or position sensor 670 such as an accelerometer, gyroscope or inertial measurement unit. The system also may receive data from a LiDAR system 660 such as that described earlier in this document.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

Terminology that is relevant to the disclosure provided above includes:

An “automated device” or “robotic device” refers to an electronic device that includes a processor, programming instructions, and one or more physical hardware components that, in response to commands from the processor, can move with minimal or no human intervention. Through such movement, a robotic device may perform one or more automatic functions or function sets. Examples of such operations, functions or tasks may include without, limitation, operating wheels or propellers to effectuate driving, flying or other transportation actions, operating robotic lifts for loading, unloading, medical-related processes, construction-related processes, and/or the like. Example automated devices may include, without limitation, autonomous vehicles, drones and other autonomous robotic devices.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. Autonomous vehicles also include vehicles in which autonomous systems augment human operation of the vehicle, such as vehicles with driver-assisted steering, speed control, braking, parking and other systems.

In this document, the terms “street,” “lane” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” may represent an airway and a lane may be a portion of the airway. If the autonomous vehicle is a watercraft, then the term “street” may represent a waterway and a lane may be a portion of the waterway.

An “electronic device” or a “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, when relative terms of order such as “first” and “second” are used to modify a noun, such use is simply intended to distinguish one item from another, and is not intended to require a sequential order unless specifically stated.

In addition, terms of relative position such as “vertical” and “horizontal”, or “front” and “rear”, when used, are intended to be relative to each other and need not be absolute, and only refer to one possible position of the device associated with those terms depending on the device's orientation. When this document uses the terms “front,” “rear,” and “sides” to refer to an area of a vehicle, they refer to areas of vehicle with respect to the vehicle's default area of travel. For example, a “front” of an automobile is an area that is closer to the vehicle's headlamps than it is to the vehicle's tail lights, while the “rear” of an automobile is an area that is closer to the vehicle's tail lights than it is to the vehicle's headlamps. In addition, the terms “front” and “rear” are not necessarily limited to forward-facing or rear-facing areas but also include side areas that are closer to the front than the rear, or vice versa, respectively. “Sides” of a vehicle are intended to refer to side-facing sections that are between the foremost and rearmost portions of the vehicle.

1. A method of predicting a state of an autonomous vehicle, the method comprising:
by an on-board electronic device of an autonomous vehicle:
at the start of a path planning cycle for an autonomous vehicle, identifying:
a current plan associated with the autonomous vehicle, wherein the current plan includes a spatial plan that defines a proposed trajectory for the autonomous vehicle during the path planning cycle and a speed plan that defines one or more velocities over time for the autonomous vehicle during the path planning cycle, and
a current state of the autonomous vehicle, wherein the current state defines one or more dynamic states of the autonomous vehicle,
generating a sequence of predicted states of the autonomous vehicle over a prediction horizon period by applying a vehicle dynamics model to the current plan and the current state;
identifying a predicted state from the sequence of predicted states that corresponds to a publishing time of an updated plan for the autonomous vehicle;
generating the updated plan, wherein the updated plan begins with the identified predicted state; and
causing the autonomous vehicle to execute the updated plan.

2. The method of claim 1, wherein the current state comprises one or more of the following:
a positional state of the autonomous vehicle;
an orientation of the autonomous vehicle;
one or more velocity vectors of the autonomous vehicle; or
one or more actuator states of the autonomous vehicle.

3. The method of claim 1, wherein the prediction horizon period is longer than the path planning cycle.

4. The method of claim 1, wherein generating a sequence of predicted states of the autonomous vehicle over a prediction horizon period comprises providing the current plan and the current state to one or more controllers associated with a path follower system of the autonomous vehicle.

5. The method of claim 4, wherein the one or more controllers comprise one or more lateral controllers and one or more longitudinal controllers.

6. The method of claim 4, wherein the one or more controllers comprise one or more model predictive controllers.

7. The method of claim 4, wherein the one or more controllers comprise one or more lateral controllers, wherein the one or more lateral controllers are configured to pass one or more steering input values that comprise one or more steering wheel angles of the autonomous vehicle through an internal model of vehicle dynamics associated with the lateral controller.

8. The method of claim 4, wherein the one or more controllers comprise one or more longitudinal controllers, wherein the one or more longitudinal controllers are configured to pass one or more torque input values through an internal model of vehicle dynamics associated with the longitudinal controller.

9. The method of claim 1, wherein causing the autonomous vehicle to execute the updated plan comprises sending one or more instructions to one or more lateral controllers of the autonomous vehicle that cause the lateral controller to steer the autonomous vehicle to achieve an updated trajectory defined by the an updated spatial plan of the updated plan.

10. The method of claim 1, wherein generating a sequence of predicted states of the autonomous vehicle over a prediction horizon period comprises:
determining one or more control input values based on the current plan and the current state of the autonomous vehicle; and
providing one or more of the one or more control input values to a vehicle model to generate the sequence of predicted states based on the provided control input values, wherein each predicted state in the sequence is a reflection of a state of the autonomous vehicle being driven by one or more of the control input values.

11. The method of claim 1, wherein causing the autonomous vehicle to execute the updated plan comprises sending one or more instructions to one or more longitudinal controllers of the autonomous vehicle that cause the one or more longitudinal controllers to adjust a speed of the autonomous vehicle to achieve a speed plan of the updated plan.

12. The method of claim 1, further comprising replacing the current plan with the updated plan.

13. A system for predicting a state of an autonomous vehicle, the system comprising:
an on-board electronic device of an autonomous vehicle; and
a computer-readable storage medium comprising one or more programming instructions that, when executed, cause the on-board electronic device to:
at the start of a path planning cycle for an autonomous vehicle, identify:
a current plan associated with the autonomous vehicle, wherein the current plan includes a spatial plan that defines a proposed trajectory for the autonomous vehicle during the path planning cycle and a speed plan that defines one or more velocities over time for the autonomous vehicle during the path planning cycle, and
a current state of the autonomous vehicle, wherein the current state defines one or more dynamic states of the autonomous vehicle,
generate a sequence of predicted states of the autonomous vehicle over a prediction horizon period by applying a vehicle dynamics model to the current plan and the current state;
identify a predicted state from the sequence of predicted states that corresponds to a publishing time of an updated plan for the autonomous vehicle;
generate the updated plan, wherein the updated plan begins with the identified predicted state; and
cause the autonomous vehicle to execute the updated plan.

14. The system of claim 13, wherein the current state comprises one or more of the following:
a positional state of the autonomous vehicle;
an orientation of the autonomous vehicle;
one or more velocity vectors of the autonomous vehicle; or
one or more actuator states of the autonomous vehicle.

15. The system of claim 13, wherein the prediction horizon period is longer than the path planning cycle.

16. The system of claim 13, wherein the one or more programming instructions that, when executed, cause the on-board electronic device to generate a sequence of predicted states of the autonomous vehicle over a prediction horizon period comprise one or more programming instructions that, when executed, cause the on-board electronic device to provide the current plan and the current state to one or more controllers associated with a path follower system of the autonomous vehicle.

17. The system of claim 16, wherein the one or more controllers comprise one or more lateral controllers and one or more longitudinal controllers.

18. The system of claim 16, wherein the one or more controllers comprise one or more model predictive controllers.

19. The system of claim 16, wherein the one or more controllers comprise one or more lateral controllers, wherein the one or more lateral controllers are configured to pass one or more steering input values that comprise one or more steering wheel angles of the autonomous vehicle through an internal model of vehicle dynamics associated with the lateral controller.

20. The system of claim 16, wherein the one or more controllers comprise one or more longitudinal controllers, wherein the one or more longitudinal controllers are configured to pass one or more torque input values through an internal model of vehicle dynamics associated with the longitudinal controller.

21. The system of claim 13, wherein the one or more programming instructions that, when executed, cause the on-board electronic device to cause the autonomous vehicle to execute the updated plan comprise one or more programming instructions that, when executed, cause the on-board electronic device to send one or more instructions to one or more lateral controllers of the autonomous vehicle that cause the lateral controller to steer the autonomous vehicle to achieve an updated trajectory defined by the an updated spatial plan of the updated plan.

22. The system of claim 13, wherein the one or more programming instructions that, when executed, cause the on-board electronic device to generate a sequence of predicted states of the autonomous vehicle over a prediction horizon period comprise one or more programming instructions that, when executed, cause the on-board electronic device to:
determine one or more control input values based on the current plan and the current state of the autonomous vehicle; and
provide one or more of the one or more control input values to a vehicle model to generate the sequence of predicted states based on the provided control input values, wherein each predicted state in the sequence is a reflection of a state of the autonomous vehicle being driven by one or more of the control input values.

23. The system of claim 13, wherein the one or more programming instructions that, when executed, cause the on-board electronic device to cause the autonomous vehicle to execute the updated plan comprise programming instructions that, when executed, cause the on-board electronic device to send one or more instructions to one or more longitudinal controllers of the autonomous vehicle that cause the one or more longitudinal controllers to adjust a speed of the autonomous vehicle to achieve a speed plan of the updated plan.

24. The system of claim 13, further comprising one or more programming instructions that, when executed, cause the on-board electronic device to replace the current plan with the updated plan.

25. A computer program product comprising a memory and programming instructions that are configured to cause a processor to:
at the start of a path planning cycle for an autonomous vehicle, identifying
a current plan associated with the autonomous vehicle, wherein the current plan includes a spatial plan that defines a proposed trajectory for the autonomous vehicle during the path planning cycle and a speed plan that defines one or more velocities over time for the autonomous vehicle during the path planning cycle, and
a current state of the autonomous vehicle, wherein the current state defines one or more dynamic states of the autonomous vehicle;
generating a sequence of predicted states of the autonomous vehicle over a prediction horizon period by applying a vehicle dynamics model to the current plan and the current state;
identifying a predicted state from the sequence of predicted states that corresponds to a publishing time of an updated plan for the autonomous vehicle;
generating the updated plan, wherein the updated plan begins with the identified predicted state; and
causing the autonomous vehicle to execute the updated plan.
